(19) United States
(12) Patent Application Publication
(10) Pub. No.: US 2011/0296666 A1
(43) Pub. Date: Dec. 8, 2011

(54) Decorative Door Cover

(76) Inventor: Robert S. Silverman, Long Beach, CA (US)

(21) Appl. No.: 13/042,405

(22) Filed: Mar. 7, 2011

Related U.S. Application Data
(63) Continuation-in-part of application No. 12/814,390, filed on Jun. 11, 2010.
Application No. 12/814,390 is a continuation of application No. 12/567,685, filed on Sep. 25, 2009.
Application No. 12/814,390 is a continuation-in-part of application No. 11/861,373, filed on Sep. 26, 2007, now Pat. No. 7,758,077.
Application No. 11/861,373 is a continuation of application No. 11/157,006, filed on Jun. 20, 2005, now Pat. No. 7,290,801.
Application No. 11/157,006 is a continuation-in-part of application No. 10/177,964, filed on Jun. 24, 2002, now abandoned.
Application No. 12/814,390 is a continuation-in-part of application No. 12/630,041, filed on Dec. 3, 2009, now abandoned.
Application No. 12/630,041 is a continuation of application No. 10/974,988, filed on Oct. 28, 2004, now Pat. No. 7,648,173.
Application No. 12/814,390 is a continuation-in-part of application No. 11/964,901, filed on Dec. 27, 2007, now abandoned.
Application No. 11/964,901 is a continuation of application No. 11/224,505, filed on Sep. 13, 2005, now Pat. No. 7,334,819.
Application No. 12/814,390 is a continuation-in-part of application No. 12/335,630, filed on Dec. 16, 2008, now Pat. No. 7,753,411.
Application No. 12/335,630 is a continuation of application No. 10/534,448, filed on May 10, 2005, now Pat. No. 7,478,837.
(60) Provisional application No. 61/100,101, filed on Sep. 25, 2008.
(60) Provisional application No. 61/165,381, filed on Mar. 31, 2009.

(51) Int. Cl. B32B 3/06; B23P 11/02

(52) U.S. Cl. 29/450; 428/99

(57) ABSTRACT

The present specification is directed toward various door covers with decorations on their exterior surface. One exemplary door cover is made of an elastomeric material that is formed in the shape of a loop and affixed to a door by stretching the loop over the ends of the door and sliding the material into place.

### CROSS REFERENCE

The present application is a continuation-in-part of U.S. patent application Ser. No. 12/814,390, filed on Jun. 11, 2010.

U.S. patent application Ser. No. 12/814,390 is also a continuation of U.S. patent application Ser. No. 12/567,685, filed on Sep. 25, 2009, which relies on U.S. Provisional Patent Application No. 61/100,101, which was filed on Sep. 25, 2008 and U.S. Provisional Patent Application No. 61/165,381, which was filed on Mar. 31, 2009.

U.S. patent application Ser. No. 12/814,390 is also a continuation-in-part of U.S. patent application Ser. No. 11/861,373, entitled “Stretchable Fabric Book Cover and Method”, and filed on Sep. 26, 2007, which is a continuation of U.S. Pat. No. 7,290,801, of the same title, which issued on Nov. 6, 2007 and is a continuation-in-part of U.S. patent application Ser. No. 10/177,964, filed on Jun. 24, 2002 and abandoned.

U.S. patent application Ser. No. 12/814,390 is also a continuation-in-part of U.S. patent application Ser. No. 12/630,041, which was filed on Dec. 3, 2009 and which is a continuation of U.S. patent application Ser. No. 10/974,988, which has issued as U.S. Pat. No. 7,648,173 on Jan. 19, 2010.

U.S. patent application Ser. No. 12/814,390 is also a continuation-in-part of U.S. patent application Ser. No. 11/964,901, which was filed on Dec. 27, 2007 and which is a continuation of U.S. patent application Ser. No. 11/224,505, which has issued as U.S. Pat. No. 7,334,819 on Feb. 26, 2008.

U.S. patent application Ser. No. 12/814,390 is also a continuation-in-part of U.S. patent application Ser. No. 12/335,630, which was filed on Dec. 16, 2008 and which is a continuation of U.S. patent application Ser. No. 10/534,448, which has issued as U.S. Pat. No. 7,478,837 on Jan. 20, 2009 and which relies on U.S. Provisional Application No. 60/425,671 filed on Nov. 11, 2002 for priority.

All of the above listed applications and patents are incorporated herein by reference in their entirety.

### FIELD OF THE INVENTION

This invention relates generally to a decorative cover used on doors. More particularly, the present invention relates to a door cover with decorations on its exterior surface made of an elastomeric material that is affixed to a door via a strap mechanism that allows for better stress distribution and therefore less displacement and/or tearing.

### BACKGROUND OF THE INVENTION

People often wish to change the aesthetic appearance of the exterior surface of a door. For example, in the U.S., many people like to decorate their front doors with images to celebrate holidays such as July 4^{th}, Halloween, Thanksgiving, and Christmas. Others may wish to decorate their doors to display their various interests or activities. College students may want to decorate their dormitory doors with their school colors, school logos, or images of their school mascots. Children may want to decorate their doors with various colors, images, or characters.

While there is a general desire to change the aesthetic appearance of an exterior surface of a door, the change is preferably temporary, readily reversible, and/or easily modifiable. For example, when celebrating July 4^{th}, Halloween, Thanksgiving, or Christmas, the door surface would preferably reflect that holiday for a limited period of time, i.e. 1-2 weeks. Similarly, college students and children may want to periodically modify the appearance of their doors with new images, characters, or logos, but without requiring the permanent application of paint.

Conventionally, decorative door covers designed to be temporary and easily removable are affixed to door surfaces using tacks, nails, tape, or other adhesives which tend to mar the door surface in some fashion. Certain prior art approaches utilize less destructive means for attachment but fail to provide a smooth, polished covered surface without buckling or folds.

For example, U.S. Pat. No. 5,123,223, assigned to Justine D. Makarevich, describes “A decorative attachment for a door, the door being generally rectangular, having opposed vertical first and second faces in spaced relation, and supported for swinging movement about an axis adjacent to a vertical longitudinal edge thereof, said decorative attachment comprising: a generally rectangular sheet extending over at least a substantial portion of the first face of the door, holding means for holding said sheet to the door, said holding means comprising at least one means defining a pocket at least one corner of said sheet, said pocket having a first portion thereof for engaging the second face of the door, and a second portion thereof extending between said sheet and said first portion for spacing said first portion from said sheet a distance approximately equal to the thickness of the door, whereby the corner of the door can be placed in said pocket, and a support for a decorative element on said sheet.”

In addition, U.S. Pat. No. 5,922,437, assigned to Monta S. Bryant, describes “An adjustable fitted cover in combination with a house door, said combination comprising: a door having a front side, a rear side and a door knob; a cover having a sheet of pliable material comprising a dimensioned and configured bag structure, said sheet covering the door, said sheet having a continuous extreme edge creating an opening tailored for passing a portion of the door therethrough, said sheet including a knob aperture with the door knob projecting therethrough, said sheet having decorative indicia; said sheet has a channel along said edge and said opening, said channel being formed by stitching said sheet upon itself, said channel being disposed in a loop on the rear side of the door; a securing means selected from the group consisting of a drawstring and an elastic ribbon, said securing means being contained within said channel; an additional channel disposed about said knob aperture; and an additional securing means selected from the group consisting of a drawstring and an elastic ribbon, said additional securing means being contained within said additional channel.”

United States Patent Application Number 20090047535, assigned to Michael G. Crilly, describes “A door cover comprising a sleeve-shaped element comprised of at least one stretchable fabric sheet which conforms to a door so as to cover a front surface, a back surface, a top side edge, and a bottom side edge along said door without obstructing the functionality of said door, said stretchable fabric material being resilient along its length so as to contract after placement onto said door.”

While the current affixing mechanisms do a good job of securing the cover without damaging the door, some are predisposed to causing tears in the cover because they concentrate the stress associated with keeping the cover in place to a small number of points. Others are not prone to cover tearing but tend to allow a greater degree of slippage of the cover along the width or length of the door. Therefore, what is needed is a door cover that is secured to the door via a mechanism that will not damage the door, will prevent displacement along the door, and will better prevent tearing by redistributing the stress associated with stretching and affixing the cover to the door.

### SUMMARY OF THE INVENTION

The present specification is directed toward a stretchable door cover for covering a door, having a first exterior surface and a second exterior surface parallel and opposite to the first exterior surface, said door cover comprising: 1) an first panel portion for covering the first exterior surface of said door cover, wherein said first panel portion is adapted to lay upon said first exterior surface without bulging; 2) four folded-in edge panel portions, each attached to said first panel portion, wherein said four folded-in edge panel portions include a first side edge panel, a second side edge panel, a top edge panel, and a bottom edge panel; said four folded-in edge panel portions are adapted to cover a top, bottom, left, and right surface of the door; an edge of said first side edge panel is attached to an edge of said top edge panel to form a first angled seam; an edge of said second side edge panel is attached to an edge of said top edge panel to form a second angled seam; an edge of said first side edge panel is attached to an edge of said bottom edge panel to form a third angled seam; an edge of said second side edge panel is attached to an edge of said bottom edge panel to form a fourth angled seam; and no seam is formed directly between said top edge panel and said bottom edge panel or between said first edge panel and said second edge panel; wherein said first, second, third, and fourth angled seams lay atop the second exterior surface, 3) at least one vertical fabric strap for connecting said top edge panel to said bottom edge panel, wherein said vertical fabric strap is configured to lay atop the second exterior surface; and 4) at least one horizontal fabric strap for connecting said first side edge panel to said second side edge panel, wherein said horizontal fabric strap is configured to lay atop the second exterior surface and wherein said door cover is comprised of a pliable material.

Optionally, the edge panels are joined in mutual secured relation by connecting means selected from the group consisting of sewing, stitching, taping, gluing, ultrasonic welding, RF welding, or heat sealing. SPANDEX yarn is employed for seam stitching. The seams are stretchable, allowing for varying seam width and length and greater flexibility of the seam. The pliable material is a fabric comprised of elastic and stretchable threads. The fabric strap is comprised of a stretchable material. The fabric strap is comprised of elastic.

In another embodiment, the specification discloses a method of manufacturing a door cover comprising the steps of cutting a laterally-elongated octagon from a sheet of elastomeric material, creating a top fold line, a bottom fold line, and side fold lines to form rectangular outer bounds of said door cover, forming at least one top edge panel by folding the material over at a top fold line, forming at least one bottom edge panel by folding the material over at a bottom fold line, forming a first side edge panel and a second side edge panel by folding the material over at a first side fold line and a second side fold line, respectively, adjoining edge panel portions; and fastening a first fabric strap and a second fabric strap to each of said top and bottom edge panels to connect and hold together said top and bottom edge panels for insertion of book covers flaps therein.

The step of adjoining edge panel portions includes attaching an edge of a first side edge panel to an edge of said top edge panel to form a first angled seam; attaching an edge of a second side edge panel to an edge of said top edge panel to form a second angled seam; attaching an edge of said first side edge panel to an edge of said bottom edge panel to form a third angled seam; and attaching an edge of said second side edge panel to an edge of said bottom edge panel to form a fourth angled seam. The edge panels are joined in mutual secured relation by attaching means selected from the group consisting of sewing, stitching, taping, gluing, ultrasonic welding, RF welding, or heat sealing. The pliant material is a fabric comprised of elastic and stretchable threads.

In another embodiment, the present application discloses a stretchable door cover for covering a door having a first exterior surface and a second exterior surface parallel and opposite to the first exterior surface, a top surface perpendicular to said first exterior surface and second exterior surface and a bottom surface perpendicular to said first exterior surface and second exterior surface, said door cover comprising a rectangular panel comprising a stretchable elastomeric material, wherein said rectangular panel has a length defined by a first end and a second end and a width, wherein said first end and said second end of the rectangular panel are attached to form a loop having a second length, and wherein said second length is less than a length of the door as defined by a distance from the top surface to the bottom surface.

Optionally, the first end and said second end are attached by connecting means selected from the group consisting of sewing, stitching, taping, gluing, ultrasonic welding, RF welding, or heat sealing. SPANDEX yarn is employed for stitching. The attachment of said first end and said second forms a seam and wherein said seam is stretchable. The loop is adapted to lay flat over said first exterior surface and said second exterior surface when stretched over the top surface and bottom surface.

In another embodiment, the present application discloses a method of decorating a door, wherein said door has a first exterior surface and a second exterior surface parallel and opposite to the first exterior surface, a first horizontal surface perpendicular to said first exterior surface and second exterior surface and a second horizontal surface perpendicular to said first exterior surface and second exterior surface, a first vertical surface perpendicular to the first horizontal surface, the second horizontal surface, the first exterior surface, and the second exterior surface, and a second vertical surface perpendicular to the first horizontal surface, the second horizontal surface, the first exterior surface, and the second exterior surface, said method comprising: 1) engaging a door cover on the first horizontal surface, wherein said door cover comprises a rectangular panel comprising a stretchable elastomeric material, wherein said rectangular panel has a length defined by a first end and a second end and a width, wherein said first end and said second end of the rectangular panel are attached to form a loop having a second length, and wherein said second length is less than a length of the door as defined by a distance from the first horizontal surface to the second horizontal surface; 2) stretching the door cover over the first vertical surface; 3) engaging the door cover on the second horizontal surface; and 4) sliding one end of said stretched door cover toward said second vertical surface and over said first exterior surface and second exterior surface, while maintaining another end of said stretched door cover proximate to said first vertical surface.

Optionally, the first end and said second end of the loops are attached by connecting means selected from the group consisting of sewing, stitching, taping, gluing, ultrasonic welding, RF welding, or heat sealing. SPANDEX yarn is employed for stitching. Attachment of said first end and said second forms a seam and wherein said seam is stretchable. The first horizontal surface is a top of the door and said second horizontal surface is a bottom of the door. The first horizontal surface is a bottom of the door and said second horizontal surface is a top of the door. The first vertical surface is a right side of the door and said second vertical surface is a left side of the door. The first vertical surface is a left side of the door and said second vertical surface is a right side of the door. The method further comprises the step of flattening the loop to lay the loop flat over said first exterior surface and said second exterior surface.

### BRIEF DESCRIPTION OF THE DRAWINGS

These and other objects and advantages of the present invention will become more fully apparent from the following detailed description when read in conjunction with the accompanying drawings with like reference numerals indicating corresponding parts throughout, wherein:

FIG. 1 is an illustration of one embodiment of the decorative door cover of the present invention during its manufacture;

FIG. 2 is an illustration of the back side of a door depicting one embodiment of the decorative door cover stretched and in place, affixed to the door and held in place via four horizontal straps and one vertical strap;

FIG. 3 is an illustration of the back side of a door depicting another embodiment of the decorative door cover stretched and in place, affixed to the door and held in place via one horizontal strap with Y attachments and one vertical strap with Y attachments;

FIG. 4 is front view of another embodiment of the decorative door cover of the present invention; and

FIG. 5 is a side view of another embodiment of the decorative door cover of the present invention.

### DETAILED DESCRIPTION OF THE INVENTION

In one embodiment, the present invention is directed toward a door cover with decorations on its exterior surface made of an elastomeric material that is affixed to a door via a strap mechanism that allows for better stress distribution. The decorative door cover is stretched across the door, much like a fitted bed sheet is stretched over a mattress, and contains excess elastomeric material that overlaps around the left side, right side, top, and bottom of said door.

In one embodiment, one or more horizontal straps are attached to the elastomeric material overlapping around each side of the door and one or more vertical straps are attached to the elastomeric material overlapping around the top and bottom of the door. In one embodiment, on the back side of the door, the one or more horizontal straps are connected via a male/female connection system and can be tightened or loosened, much like the straps on a backpack. In the same embodiment, on the back side of the door, the one or more vertical straps are connected via a male/female connection system and can be tightened or loosened, again much like the straps on a backpack. In various embodiments, other connection systems can be employed that allow for the connection, tightening, and loosening of the straps.

The present invention is directed toward multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

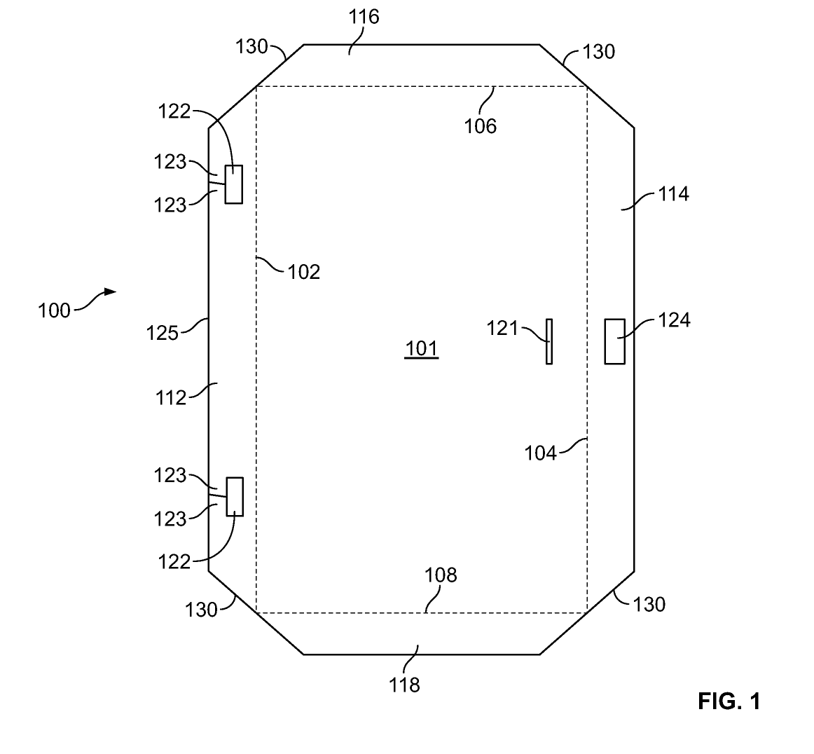

FIG. 1 is an illustration of one embodiment of the decorative door cover 100 of the present invention during its manufacture. At this stage of manufacture, the door cover 100 comprises one flat sheet of elastomeric material with an exterior facing decorative area 101 delineated by a left fold line 102, right fold line 104, top fold line 106, and bottom fold line 108. Extending beyond the left fold line 102 is the left excess area 112 of the door cover 100 which will be in contact with the left and back side of the door when the door cover 100 is complete and in place.

Optionally, the left excess area 112 contains two rectangular openings 122 proximate the top and bottom to accommodate door hinges when the door cover 100 is in place. These openings 122 are accessible via flaps 123 that extend from said openings 122 to the left edge 125 of the door cover 100. In one embodiment, once the left excess area 112 has been placed over the door hinges, these flaps 125 are held together by Velcro strips. In various embodiments, the flaps 125 are held together by other similar fastening mechanisms. In another embodiment, these openings and flaps are positioned on the right excess area for opposite facing doors. Optionally, the left excess area 112 does not contain the rectangular opening 122. The elastomeric material used is sufficiently thin to permit the left excess area 112 to fold around the hinges without causing buckling, folding, or bulging of decorative area 101 relative to the exterior door surface.

Extending beyond the right fold line 104 is the right excess area 114 of the door cover 100 which will be in contact with the right and back side of the door when the door cover 100 is complete and in place. The right excess area 114 contains one rectangular opening 124 proximate the center to accommodate door locking and bolting mechanisms when the door cover 100 is in place. In another embodiment, this opening is positioned on the left excess area for opposite facing doors. Optionally, the right excess area 114 does not contain the rectangular opening 124. The elastomeric material used is sufficiently thin to permit the right excess area 114 to cover a protruding member, such as a bolt, from the deadlatch or bolt mechanism as it engages the latch hole in the door frame without having the door lock mechanism be compromised. For example, when the door is in a locked state, the material-covered bolt will still remain affixed within the latch hole and will not become slidably removable solely because it is now covered with a material. Similar, when the door is in an unlocked state, the material-covered bolt will still remain affixed within the latch hole and will not become slidably removable in the absence of a person rotating the door knob solely because it is now covered with a material.

Extending beyond the top fold line 106 is the top excess area 116 of the door cover 100 which will be in contact with the top and back side of the door when the door cover 100 is complete and in place. Extending beyond the bottom fold line 108 is the bottom excess area 118 of the door cover 100 which will be in contact with the bottom and back side of the door when the door cover 100 is complete and in place. Each of the excess areas 112, 116, 114, 118 therefore defines a trapezoid and, more specifically, an isosceles trapezoid.

The exterior facing decorative area 101 contains images that, in various embodiments, are painted, glued, stitched, or affixed in some similar manner to the door cover 100. When in place, the exterior facing decorative area 101 will be in contact with the front of the door. Optionally, in one embodiment, the exterior facing decorative area 101 contains a rectangular slit 121 proximate the center of its right side to accommodate door knobs and handles and to lay closed and not look like a hole when no door knob or handle is passed through said slit. Optionally, in another embodiment, this slit is positioned proximate the center of the left side of the exterior facing decorative area for opposite facing doors.

As can be seen in FIG. 1, the top and bottom edges of excess areas 112 and 114 and right and left edges of excess areas 116 and 118 are all cut at angles, thereby creating an elongated octagon with a rectangular area defined therein by fold lines. The starting structure 100 therefore comprises a rectangular structure with triangular areas at all four corners of the door cover 100 cut out. Once the door cover 100 is folded along its fold lines 102, 104, 106, 108, the cut edges 130 of the excess areas 112, 114, 116, 118 are brought into contact with each other at all four corners. In one embodiment, these edges 130 are stitched together, e.g. the top edge of area 112 is attached to the left edge of area 116, the right edge of area 116 is attached to the top edge of area 114, the bottom edge of area 114 is attached to the right edge of area 118, and the left edge of area 118 is attached to the bottom edge of area 112, thereby creating a pocket along the interior perimeter of the entire door cover 100. In various embodiments, the edges 130 are connected via taping, gluing, metal fasteners, stitching, sewing, Velcro, ultrasonic welding, RF welding, heat sealing, or other alternative forms of connection.

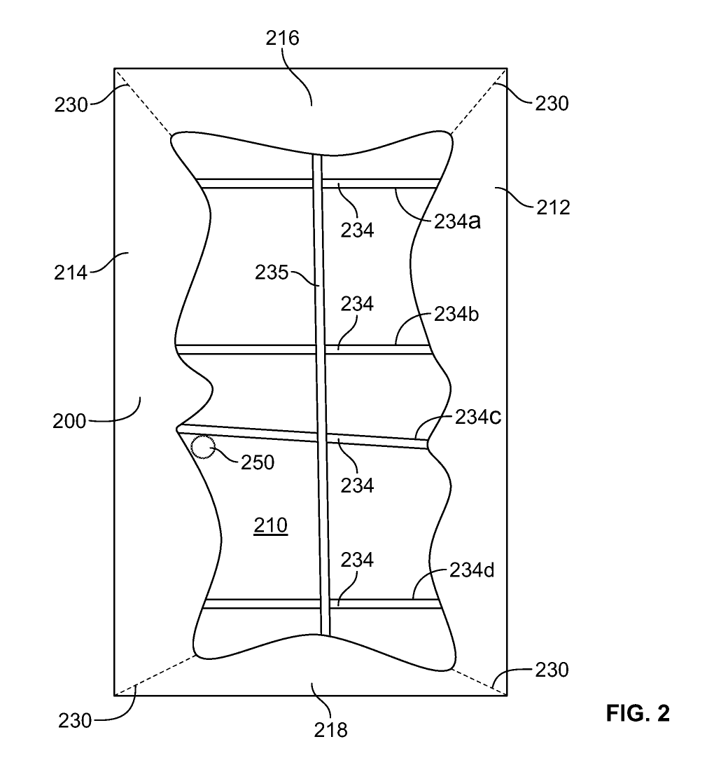

FIG. 2 is an illustration of the back side of a door 210 depicting one embodiment of the decorative door cover 200 stretched and in place, affixed to the door 210 and held in place via four horizontal straps 234 and one vertical strap 235. The attached edges 230 of the excess areas can also be seen in each corner. In one embodiment, the left edge of the door cover 200 stretches around the interior door knob 250. In one embodiment, each strap 234, 235 is a fabric and/or elastic strip that connects along the back side of the door and can be tightened and loosened by the user.

Preferably, the straps 234, 235 are placed in particular positions along the door cover for better stress distribution on the exterior facing decorative area, resulting in a more polished, clean look. In one embodiment, for door covers designed to fit standard rectangular doors (32-36″ in width and 80-84″ in height), the un-stretched exterior facing portion of the decorative door cover measures 34″ wide by 54″ tall. The excess areas extend beyond this area on all four sides. In one embodiment, in the un-stretched configuration, the topmost horizontal strap 234a is attached to the left 214 and right 212 excess areas and positioned 12″ down from the top fold line. In the same embodiment, in the un-stretched configuration, the top middle horizontal strap 234b is attached to the left 214 and right 212 excess areas and positioned 24″ down from the top fold line. In the same embodiment, in the un-stretched configuration, the bottom middle horizontal strap 234c is attached to the left 212 and right 214 excess areas and positioned 24″ up from the bottom fold line. In the same embodiment, in the un-stretched configuration, the bottommost horizontal strap 234d is attached to the left 212 and right 214 excess areas and positioned 12″ up from the bottom fold line. In the same embodiment, in the un-stretched configuration, the top middle 234b and bottom middle 234c horizontal straps end up being positioned 6″ apart. In the same embodiment, in the un-stretched configuration, the vertical strap 235 is attached to the top 216 and bottom 218 excess areas and is positioned in the middle of the door cover.

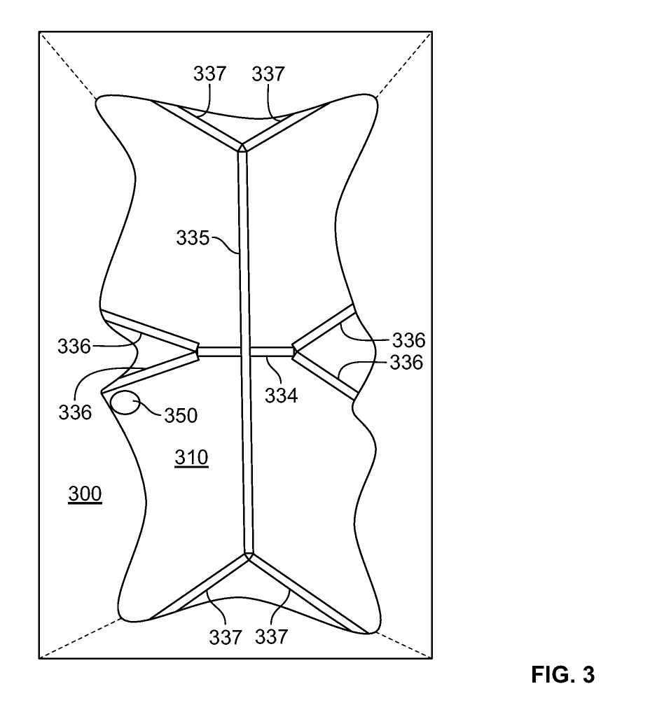

FIG. 3 is an illustration of the back side of a door 310 depicting another embodiment of the decorative door cover 300 stretched and in place, affixed to the door 310 and held in place via one horizontal strap 334 with Y attachments 336 and one vertical strap 335 with Y attachments 337. The horizontal strap 334 with Y attachments 336 is positioned proximate the center of the door cover 300 when measured along its height. The vertical strap 335 with Y attachments 337 is positioned proximate the center of the door cover 300 when measured along its width. In one embodiment, the edges of the door cover 300 stretch around the interior door knob 350. The use of only one strap with Y attachments both horizontally and vertically enhances ease of usability by decreasing the number of straps while still providing better stress distribution along the front of the cover.

In one embodiment, the elastomeric material used to construct the door cover allows for the door to close with the lock being covered but does not compromise the door locking mechanism. In one embodiment, in which the door has a window or glass, the elastomeric material is such that it generally allows people inside a room to look through the glass/window while still sufficiently blocking the view of people outside the room.

In the embodiments described herein, the straps comprise an adjustment means for connecting, tightening, or loosening the straps, such as clips, buckles, strap adjusters, cams, snaphooks, dual adjust side release buckles, ladderlock straps, lash straps, line tighteners, tabular buckle, day buckle, single side release buckle, or double bar buckle. The vertical strap is preferably connected at each end to the top and bottom panels, with the adjustment means providing for a mechanism of tightening the strap. The horizontal straps are preferably connected at each end to the first and second edge panels, with the adjustment means providing for a mechanism of tightening the straps. It should be appreciated that each strap described herein could comprise multiple separate straps which are adjoined together.

The door cover may be manufactured by taking a rectangular section of pliant material, such as elastomeric material, and cutting a laterally-elongated octagon therefrom. Fold lines are then created at a top fold line, a bottom fold line, and side fold lines to form the rectangular outer bounds of the door cover. At least one top edge panel is formed by folding the material over at a top fold line, at least one bottom edge panel is formed by folding the material over at a bottom fold line, and a first side edge panel and a second side edge panel are formed by folding the material over at a first side fold line and a second side fold line, respectively. The edge panel portions are then affixed to each other by any of the means described above. The vertical fabric strap is attached to the top and bottom edge panels. The horizontal fabric strap(s) are each attached to the first and second edge panels.

For some users, the back side of the door with the cover's excess areas and straps may appear unsightly. In one embodiment, a back door cover is included with the decorative door cover. In one embodiment, the back door cover is a rectangular material whose length and width measures slightly smaller than a standard door. In one embodiment, the back door cover attaches to the excess areas of the decorative door cover via Velcro strips positioned in each corner of the door. Velcro strips are attached to the excess areas of the decorative door cover such that the strips end up facing the interior of the room once the decorative door cover is in place and are ready to accept complementary Velcro strips attached to the back door cover. In one embodiment, the back door cover contains a rectangular slit proximate the center of its left side to accommodate and door knob and to lay flat and not look like a hole when no door knob is passed through. In another embodiment, the slit is positioned proximate the center of the right side of the back door cover for opposite facing doors. In one embodiment, the back door cover is one solid color. In other various embodiments, the back door cover also contains images which are similar to those depicted on the decorative door cover.

In another embodiment, the door cover comprises a loop made of stretchable elastomeric material. The loop is manufactured by cutting a rectangular panel of stretchable elastomeric, preferably having dimensions in or around 30 inches×120 to 180 inches, preferably 150 inches or 163 inches, and attaching the ends of the rectangular panel together to form a loop. The first end and second end of the loop are attached by connecting means selected from the group consisting of sewing, stitching, taping, gluing, ultrasonic welding, RF welding, or heat sealing. In one embodiment, SPANDEX yarn is employed for stitching. Attachment of the first end and second end forms a stretchable seam.

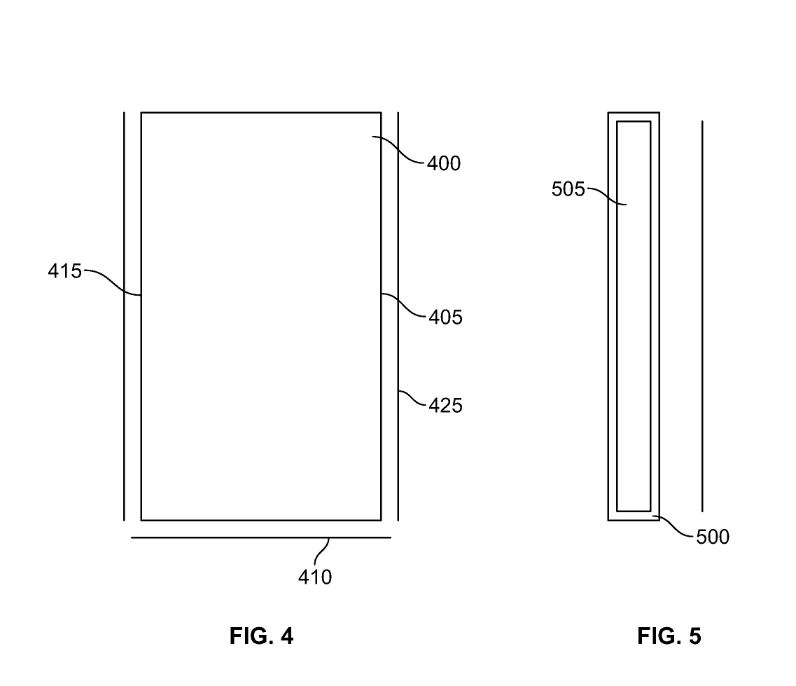

Referring to FIGS. 4 and 5, an exemplary door cover 400, 500 comprising a stretchable loop is shown. To use the door cover 400, the loop is engaged over one end of the door (either the top or bottom, or first horizontal surface or second horizontal surface) and the interior of the loop 505 is stretched over the right or left end of the door (first vertical surface or second vertical surface), and then engaged over the other end of the door. One end of the door cover 405 is then slid toward a second vertical surface and over the exterior surfaces of the door, while maintaining the other end 415 of the stretched door cover proximate to the first vertical surface. This results in a completely covered door with the loop width equal to the door width 410 and the loop length stretched to encompass the entirety of the door length 425, including the front of the door, back of the door, top of the door, and bottom of the door. It should also be appreciated that, before being installed on a door and in its unstretched form, the length of the loop is less than the length of the door 425. It should further be appreciated that the elastomeric material should be smoothed so that it lays flat over the front and back door surfaces.

It should be appreciated that a standard door has a first exterior surface and a second exterior surface parallel and opposite to the first exterior surface, a first horizontal surface perpendicular to said first exterior surface and second exterior surface and a second horizontal surface perpendicular to said first exterior surface and second exterior surface, a first vertical surface perpendicular to the first horizontal surface, the second horizontal surface, the first exterior surface, and the second exterior surface, and a second vertical surface perpendicular to the first horizontal surface, the second horizontal surface, the first exterior surface, and the second exterior surface.

Although the present invention has been particularly shown and described above with reference to the above described embodiments, it is anticipated that alterations and modifications thereof will no doubt become apparent to those skilled in the art. It is therefore intended that the following claims be interpreted as covering all such alterations and modifications as fall within the true spirit and scope of the invention.

1. A stretchable door cover for covering a door having a first exterior surface and a second exterior surface parallel and opposite to the first exterior surface, said door cover comprising:
a. an first panel portion for covering the first exterior surface of said door cover, wherein said first panel portion is adapted to lay upon said first exterior surface without bulging;
b. four folded-in edge panel portions, each attached to said first panel portion, wherein
i. said four folded-in edge panel portions include a first side edge panel, a second side edge panel, a top edge panel, and a bottom edge panel;
ii. said four folded-in edge panel portions are adapted to cover a top, bottom, left, and right surface of the door;
iii. an edge of said first side edge panel is attached to an edge of said top edge panel to form a first angled seam;
iv. an edge of said second side edge panel is attached to an edge of said top edge panel to form a second angled seam;
v. an edge of said first side edge panel is attached to an edge of said bottom edge panel to form a third angled seam;
vi. an edge of said second side edge panel is attached to an edge of said bottom edge panel to form a fourth angled seam; and
vii. no seam is formed directly between said top edge panel and said bottom edge panel or between said first edge panel and said second edge panel; wherein said first, second, third, and fourth angled seams lay atop the second exterior surface.
c. at least one vertical fabric strap for connecting said top edge panel to said bottom edge panel, wherein said vertical fabric strap is configured to lay atop the second exterior surface; and
d. at least one horizontal fabric strap for connecting said first side edge panel to said second side edge panel, wherein said horizontal fabric strap is configured to lay atop the second exterior surface and wherein said door cover is comprised of a pliable material.

2. The stretchable door cover of claim 1 wherein said edge panels are joined in mutual secured relation by connecting means selected from the group consisting of sewing, stitching, taping, gluing, ultrasonic welding, RF welding, or heat sealing.

3. The stretchable door cover of claim 2 wherein a SPANDEX yarn is employed for seam stitching.

4. The stretchable door cover of claim 1 wherein said seams are stretchable, allowing for varying seam width and length and greater flexibility of the seam.

5. The stretchable door cover of claim 1 wherein said pliable material is a fabric comprised of elastic and stretchable threads.

6. The stretchable door cover of claim 1 wherein said at least one fabric strap is comprised of a stretchable material.

7. The stretchable door cover of claim 6 wherein said at least one fabric strap is comprised of elastic.

8. The stretchable door cover of claim 1 wherein said vertical fabric strap and horizontal fabric strap each comprise at least one adjustment means.

9. The stretchable door cover of claim 1 further comprising a rectangular back panel having a plurality of Velcro strips, wherein said back panel is adapted to attach to the edge panels and lay atop the second exterior surface.

10. A stretchable door cover for covering a door having a first exterior surface and a second exterior surface parallel and opposite to the first exterior surface, a top surface perpendicular to said first exterior surface and second exterior surface and a bottom surface perpendicular to said first exterior surface and second exterior surface, said door cover comprising a rectangular panel comprising a stretchable elastomeric material, wherein said rectangular panel has a length defined by a first end and a second end and a width, wherein said first end and said second end of the rectangular panel are attached to form a loop having a second length, and wherein said second length is less than a length of the door as defined by a distance from the top surface to the bottom surface.

11. The stretchable door cover of claim 10 wherein said first end and said second end are attached by connecting means selected from the group consisting of sewing, stitching, taping, gluing, ultrasonic welding, RF welding, or heat sealing.

12. The stretchable door cover of claim 11 wherein a SPANDEX yarn is employed for stitching.

13. The stretchable door cover of claim 10 wherein attachment of said first end and said second end forms a seam and wherein said seam is stretchable.

14. The stretchable door cover of claim 10 wherein said loop is adapted to lay flat over said first exterior surface and said second exterior surface when stretched over the top surface and bottom surface.

15. A method of decorating a door, wherein said door has a first exterior surface and a second exterior surface parallel and opposite to the first exterior surface, a first horizontal surface perpendicular to said first exterior surface and second exterior surface and a second horizontal surface perpendicular to said first exterior surface and second exterior surface, a first vertical surface perpendicular to the first horizontal surface, the second horizontal surface, the first exterior surface, and the second exterior surface, and a second vertical surface perpendicular to the first horizontal surface, the second horizontal surface, the first exterior surface, and the second exterior surface, said method comprising:
a. Engaging a door cover on the first horizontal surface, wherein said door cover comprises a rectangular panel comprising a stretchable elastomeric material, wherein said rectangular panel has a length defined by a first end and a second end and a width, wherein said first end and said second end of the rectangular panel are attached to form a loop having a second length, and wherein said second length is less than a length of the door as defined by a distance from the first horizontal surface to the second horizontal surface;
b. Stretching the door cover over the first vertical surface;
c. Engaging the door cover on the second horizontal surface; and
d. Sliding one end of said stretched door cover toward said second vertical surface and over said first exterior surface and second exterior surface, while maintaining another end of said stretched door cover proximate to said first vertical surface.

16. The method of claim 15 wherein said first end and said second end of the loops are attached by connecting means selected from the group consisting of sewing, stitching, taping, gluing, ultrasonic welding, RF welding, or heat sealing.

17. The method of claim 16 wherein a SPANDEX yarn is employed for stitching.

18. The method of claim 15 wherein attachment of said first end and said second forms a seam and wherein said seam is stretchable.

19. The method of claim 15 wherein said first horizontal surface is a top of the door and said second horizontal surface is a bottom of the door.

20. The method of claim 15 wherein said first horizontal surface is a bottom of the door and said second horizontal surface is a top of the door.

21. The method of claim 15 wherein said first vertical surface is a right side of the door and said second vertical surface is a left side of the door.

22. The method of claim 15 wherein said first vertical surface is a left side of the door and said second vertical surface is a right side of the door.

23. The method of claim 15 further comprising the step of flattening the loop to lay the loop flat over said first exterior surface and said second exterior surface.
